(19) United States
(12) Patent Application Publication
(10) Pub. No.: US 2010/0094635 A1
(43) Pub. Date: Apr. 15, 2010

(54) System for Voice-Based Interaction on Web Pages

(76) Inventor: Juan Jose Bermudez Perez, Barcelona (ES)

Correspondence Address: SHOEMAKER AND MATTARE, LTD, 10 POST OFFICE ROAD - SUITE 100, SILVER SPRING, MD, 20910, US

(21) Appl. No.: 12/520,654

(22) PCT Filed: Nov. 30, 2007
(86) PCT No.: PCT/ES2007/000692

§ 371 Date: Jun. 22, 2009

(30) Foreign Application Priority Data
Dec. 21, 2006 (ES) P200700013

(51) Int. Cl. G10L 15/00; G10L 21/00; G06F 3/16; G10L 11/00

(52) U.S. Cl. 704/270.1; 704/275; 704/235; 715/728; 704/E15.001; 704/E21.001; 704/E11.002

(57) ABSTRACT

SYSTEM FOR VOICE-BASE INTERACTION ON WEB PAGES, of type that permits the incorporation of voice-handling functions on a Web page, in which from a Terminal (1) a Web page (3) of a Web site that is structured under the DOM (Domain Object Model), or any of its extensions, and a networked Voice Service Server (5), by means of a downloadable module (6) for further incorporation in a Web browser, the system including the operating procedures for enabling said module to act as a transparent gateway in a dialogue between said Voice Service Server (5) and said Web page (3), said Web browser permitting to handle said Voice Services of said Server (5) through script functions incorporated in said Web page (3).

### FIELD OF THE INVENTION

The object of the present invention is a system for voice-based interaction on web pages of the type permitting a browser to respond to oral sentences by means of further oral sentences by modifying the content of the browser in a visible or not visible way, said system featuring the particularity that is configured upon the basis of a downloadable module that encodes the user's voice and connects with a voice server that returns to the web page and the user's terminal the processed information related to the voice operation performed, said system providing, among other functions, spoken recognition instructions, voice decoding for texts, user identification, voice message storage, voice-based interaction, etc.

### PRIOR ART

In the interaction with a user of a terminal accessing the Web page of a Web site through a browser, it is often missed the agility that voice-based communication with the browser would provide. This, as undoubtedly necessary for people having some manual or visual disability as it is, becomes in general desirable for any user.

It is to meet the above users' demand that different fields of the art have been striving to provide browsers with such a functionality and, in fact there exist several documents that deal with this issue.

For instance, WO02/073599 develops a method for utilizing voice to manage use of the Web browser. In a brief explanation said document discloses a state machine associated with the Web page in such a way that is not necessary to perform changes neither on the existing pages nor on the corresponding visualization files thereof.

As described in said document, whenever the client accesses the Web page he/she is transferred the software stored in the server that provides the client with voice synthesis and recognition of the characters to be employed.

As far as the Web site is concerned, this method involves the existence of a tree structure for the voice-configuring files that is parallel to that of the pages of the Web site. Voice-configuring files comprise states representing the interaction between the user and the page. Each state of said interaction comprises five sections: ASR (Automatic Speech Recognition), CMD (the commands), TTS (Text-to-Speech), ADV (oral warning messages), MOV (movement commands for Avatar-type animated graphics).

Furthermore, WO99/48088 develops a system and method for implementing a voice-controlled Web browser program executing on a wearable computer. The Web page is precompiled at a server computer to generate a speech grammar that is transmitted with its corresponding Web document to the wearable computer.

It is known the existence and the application of browsers that incorporate among their functionalities the possibility of enabling users to issue voice commands for their actions, such as the Opera version 9.02 (© Opera Software ASA) browser, which utilizes the “IBM Multimodal Runtime Environment”. “Go to”, “close”, “next” commands and the like, specifically in English, enable the browser to react as desired by the user. Currently, this functionality is not only provided for PC Web browsers but it is also known in other types of operating environments, such as cell phone menus or multi-purpose hands-free devices that are activated by the user through voice commands that are checked by the device or program in question against a register of commands that has previously been created and in the event that the command matches it is executed.

Obviously, providing a more sophisticated voice-based interaction for Web pages grows increasingly complex as more voice actions are to be contemplated. Further, on Web sites it would be desirable to perform voice-prompted actions that are more complex than simple browsing of the type, for instance, of “show me the most interesting titles of your catalogue”. The present invention consequently intends to tackle these problems by providing a system that enables complex interaction between the user and the Web page browser and is not limited to mere Web browsing, thereby avoiding the cumbersome need to create one's own Web page or the possession of specialized software by the client Terminal.

Thus, it is the main object of the present invention to provide a system for voice-based interaction on Web pages based on a downloadable module that acts as a transparent gateway with a remote speech service server, so as to enable said system to perform actions associated with voice handling and related to the Web site and the visited Web page.

It is another of the objects of the present invention to equip the designer of developer of the Web page with a protocol for establishing the decision rules in respect of the voice-based interactions between the user and the Web page, thereby permitting a greater suitability of the page services to the existing technological capabilities.

And it is yet another of the main objectives of the present invention to provide a system that enables concurrent interaction of multiple users on a Web page, so that there is no need in said page for all the corresponding states to be configured to meet any possible users' requests, it being feasible that said requests are independent of the configuration of the Web page, which, according to the present invention, can handle them.

These and other objects of the present invention will become apparent from the description of same that is included in the present patent specification.

### BRIEF DESCRIPTION OF THE INVENTION

The object of the present invention is a system for voice-based interaction on Web pages of the type that enables a browser, by means of a user's speech, to respond to this user's requests by modifying the content of the information displayed or any of its inner parameters.

The system comprises a terminal, this concept meaning in the present invention any device capable of showing through visualization means the content of a Web page, including consequently computers, cell phones, hand-held computers, laptops, digital televisions, etc.

It also comprises a downloadable module that incorporates the functions needed by each terminal for the voice received from the user to be interpreted and encoded for re-transmission thereof in the network, including a user identifier such as his/her IP and the visited page.

One or a plurality of Web pages of a Web site whose content is structured by standards such as the DOM model incorporate means for the accreditation of use of the System of the present invention, the functions to be performed that are associated with the results of the speech instructions and calls to voice procedures linked to elements of said Web page with the transmission of suitable parameters to each of them.

Also, it includes a speech service server that receives the request for voice service from said downloadable module by receiving from said message Terminal audio messages that have been compressed and encoded by said module, said speech service server being also provided with the required procedures for interpreting the message and act in accordance with a series of actions that are configured in said server and are related to the application or context instructions received with said speech.

The voice server utilizes AI (Artificial Intelligence) resources to adequately respond to any requested data flow and functions received from any user, terminal and Web page, so that suitable instructions can be transmitted to said downloadable voice module in order that the adequate script on the Web page becomes executed in response to the voice-based interaction performed by means of the API of the SO terminal or the corresponding DOM information structure included in the browser.

### BRIEF EXPLANATION OF THE DRAWINGS

In order to facilitate understanding of the specification it is accompanied by drawings of the invention by way of example and not limitation of the inventive object of same, wherein like reference numerals are applied to like elements.

FIG. 1 shows a schematic representation of the parts of the system of the invention and how they are mutually related.

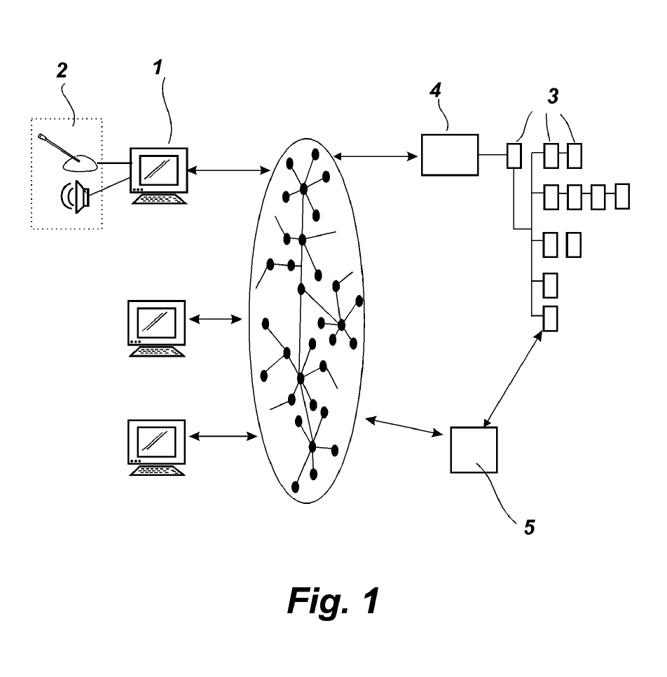

FIG. 2 represents a block diagram that partially illustrates the flow of processes that takes place in the present invention between the parts comprising the system.

FIG. 3 itemizes in a block diagram the process flow for a particular embodiment in which the system of the invention is utilized to request a remote voice-handling service, this being the most general case of utilization of the invention.

FIG. 4 details in respect of the process described in the preceding figure the possible message interaction between the downloadable voice module and the Web page, in accordance with the system described in the present invention.

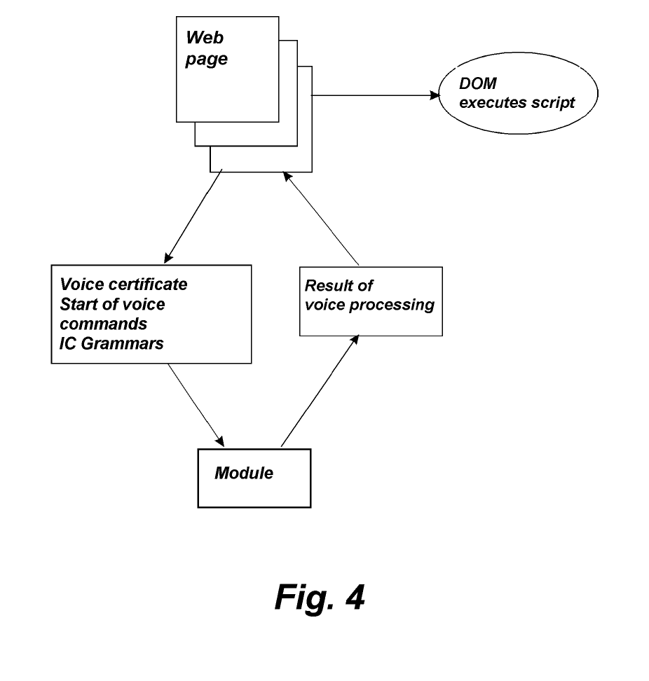

### DETAILED EXPLANATION OF THE INVENTION

The invention consists of a system for voice-based interaction on Web pages of the type that enables a browser to respond to oral sentences through by modifying the content of the browser in visible or not visible way.

The system includes a Terminal (1) capable of displaying and browsing Web pages (3) of a Web site thanks to a browser that can be any browser known in the art. The concept of Terminal (1) used in the present invention is broader than that of the conventional desktop computer and is not limited to it. In fact, it is deemed to be included within this characterization any support capable of displaying and handling Web pages, such as hand-held computers, laptops, cellular phones, digital televisions, video game consoles, etc.

Said Terminal (1) is provided with microphone-type means for capturing the user's voice and reproducing sound, hereinafter called capturing and sound-reproducing means (2).

The Terminal browser (1) gains access through any global communications network, in the preferred embodiment of the invention: the Internet, to a Web site from which it receives Web pages (3) that said Terminal (1) displays to the user of same on his/her browser.

Said Web page, for the user to be able to interact by means of the voice according to the system described in the present invention, has its content structured thanks to a DOM type model and includes a certificate of implementation of the present invention, script or the like type language functions associated with the voice-based interaction and ready to respond to said voice-based interaction, and one or a plurality of elements that become configured by requesting voice resources.

The system of the invention includes a downloadable voice module (6), as an existing resource in the Web, which is associated with the browser as a module or plugin of same. Said module (6) contains the operational procedures needed for decoding the user's speech and transmission thereof through the network in combination with some other identifying datum of the Terminal (1), conventionally the IP of said Terminal (1), context instructions associated with voice handling, the grammar to be used, etc.

In this way whenever the user accesses a Web page (3) aimed to be used in accordance with the present invention, the Browser is queried about the presence of said module (6) for optional installation in the event it is not installed yet. This all is performed in the conventional fashion by means of any script embedded in the Web page (3) or any known alternative procedure.

Whenever a user gives instructions to the Browser from his/her capturing and sound-reproducing means, the module (6) performs the encoding of said oral speech by compressing the same optionally using therefor audio-compressing algorithms for optimal transmission through the network. Prior to the transmission process of said compressed speech to the network, said module (6) performs the packing of same and associates it with said identifier in the network of said Terminal (1), it being used for the sake of simplicity the IP address in the network of the Terminal or any other identification, or even a subscription key to the voice service without this altering the invention.

The above-mentioned packing also includes the Web page (3) for which the user's instruction is intended. Conventionally, said pages can be identified through a path from a network address, said path being added a subpath that leads to the referenced page.

In the preferred embodiment, in which the Internet is the global network, the transmission protocol of the packing, or more precisely speaking, of the group of blocks to be transmitted is the TCP/IP. Said blocks or packages are sent to a voice Server (5) for processing. Said voice server (5) can be one single server or a cluster of servers placed in different geographic locations and having different node addresses of the global network. In one of the possible embodiments of the invention it is the server of the Web site (4) itself that performs the voice server (5) functions.

The voice server (5) performs on its part the decoding of the speech received and interprets the content of the message specified by the user of the Terminal (1). Actually, the message transmitted by said voice module (6) incorporated, in addition to the encoded voice flow, context instructions for the interpretation of said message. Thus, the voice Server firstly identifies the group of suitable programs for performing information processing, depending on said context, that is, the function that has been requested of it.

The message can consist of simple browsing commands of the type known in the prior art such as: “go ahead”, “back”, etc., or some word for identifying some particular user, or simply a welcome message to be stored and subsequently retrieved . . . Said message can also consist of more complex operations related to some specific Web page (3). For instance, on a Web page (3) of a Web site devoted to automobiles sales, users may respond to a general help offer through multimedia means inserted in said page, such as “Would you like information on some particular vehicle?”, with a general request as general as “Show me the latest models”.

There is at this stage from the point of view of the present invention two significant technical problems to solve in order to deal with a complex question in a concurrent environment with a plurality of users and in a global network, such as the Internet.

The first problem has to do with the “interpretation” of the user's speech. Fortunately, this is a known technical problem that, despite it does not have an absolutely satisfactory solution, achieves a high standard of efficiency when the working environment of the agents intended to interpret the sentence are delimited beforehand, said agents in this case at hand being related to a particular Web page having both a known vocabulary and grammar.

The invention utilizes any of the known means for decoding the speech originating from the Terminal (1). Specifically, sound digitalization and the analysis thereof, biometric analysis of voice patterns, etc. As a result of this analysis the voice Server (5) is capable of transforming the user speech that it has received in a compressed and packed version into a data matrix containing information on the initiating Terminal (1), the referenced Web page (3) and a user phrase or sentence with its corresponding instruction.

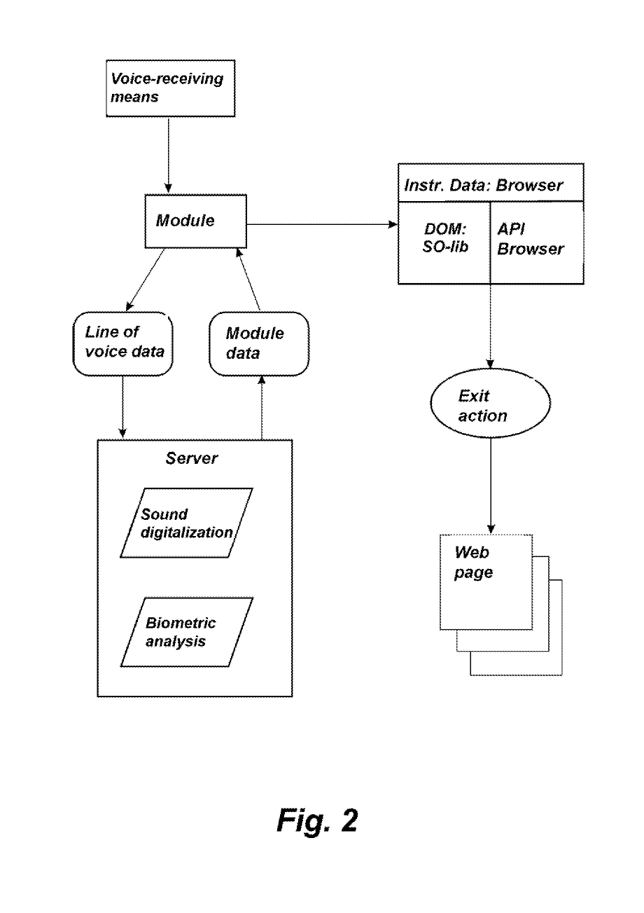

The voice server (5), by means of IA agents that have been implemented in the system, analyses through ASR (Automatic Speech Recognition) functions like the ones above described the speech received and interprets it in order to therefrom construct an instructions game or “module data” (in accordance with the representation of FIG. 2) which will eventually be transmitted back to the Terminal (1) and are intended for said module (6) that is incorporated into the Browser.

This “module data” transmission, that is performed through the global network, incorporates packed information including the Terminal (1) ID, usually the IP, the ID of the referenced Web page (3), and the set of instructions that the user instruction has represented.

It must be emphasized that voice processing, in accordance with the requested context, does not always yield a fully reliable result. Actually, the system regards the result associated with the requested context as a datum and a reliability margin. In a trivial example a user identifies himself/herself through the reading of his/her user name that is registered by the Terminal (1) voice means and encoded by the voice module (6). The voice Server (5) can be incapable of determining the equivalence of the user ID with the voice of said user by improving an uncertainty margin, which is logical since it is not always possible to suppress all the perturbation sources associated with a voice context: room noise, poor voice quality, etc. The result is in consequence offered in association with the uncertainty margin of same.

The module (6) acts on the Browser following, as set forth above, the DOM model, in any of its known standards or extensions. DOM is the acronym for “Document Object Model” and is a standard kept by the World Wide Web Consortium (W3C) to represent the elements forming a structured document, such as a Web page, or any XML or XHTML document. Said page objects of the DOM model have their own methods and properties that configure them as an API (Application Programming Interface), a set of communication specifications between components, so that in a dynamic way it is possible to access the contents of a Web page, and add and change the elements and information that it contains.

In this way interaction between said module (6) and the Web page (3) becomes smooth. Firstly, for receiving the certificate according to which the Web page (3) conforms to the system of the present invention. Secondly, for getting said page to inform the module (6) that a voice procedure associated with a specific event or context of the page is initiated, such as voice-based identity recognition of a given user. Finally, for executing the corresponding procedure associated with a voice process, such as accepting said identity and opening its personal profile in said Web Site in response to the reception of said voice-based identity recognition by said voice module (6) in said Web page (3).

The module (6) can also use the API of each browser into which it has been installed in order to alter the dynamic content of the page or respond to commands concerning the browser itself, such as simple browsing commands.

In one of the possible embodiments of the invention, room has been given to the possibility that the module (6) acts on the very library of functions of the operating system for executing actions on the Terminal (1). Although, in principle and in accordance with the present invention there are no limitations as to the accessible functions of the operating system of the Terminal (1), in the preferred embodiment said functions are limited for security reasons, in order to avoid security breaches that might damage the system in the Terminal (1).

The system of the invention could be used for incorporating complex voice-associated procedures without it being necessary to implement said procedures neither in the page nor with software intended for that purpose in each client Terminal (1). The system of the invention provides a transparent gateway for the voice services so that Web page developers can incorporate them therein by way of an interaction sublanguage that uses DOM architecture for communicating the component, plugin or module (6) with the browser. The system allows the Web page (3) to store the status information required for the browsing, said information not being used by the voice server (5) as it is limited to execute commands transmitted from said module (6) by the Web page (3).

In fact, as has been described above throughout the present specification, one of the main advantages of the present invention is that user can engage in complex interactions that are not merely limited to entering simple browsing data or manipulating page objects. In this case at hand, the Web page incorporates in its element structure the properties from which it is possible to obtain a complex response.

One of the cases, although the invention is not limited to it, comprises an Avatar or animated figure that executes dialogues with the user of the Web page. The Avatar queries the user and the user responds. The response may make sense, be misinterpreted or be perfectly processed by the Voice Server (5). For the Voice Server (5) to be capable of suitably interpreting the user speech it needs to also know via DOM the functions accepted by the Web page (3) originating the message flow.

In this way, in this type of pages requiring the module (6) for their correct operation as well as the scripts that require the presence of the module (6) in the browser used, the context and the elements that can process the responses to the queries made by the page are transmitted in the packages of the communications between the module (6) and the voice Server (5).

Furthermore, the system incorporates into said transmission a subscription ID for identifying in the voice Server (5) a grammar peculiar to the Web site where said Web page (3) is located in order to permit the efficient work of the IA agents whose function is to process the user's speech.

The invention will be better understood through the explanation of several embodiments of same that are to be regarded as simple applications not intended to limit the scope of the invention.

### General Call for Remote Voice-Based Service

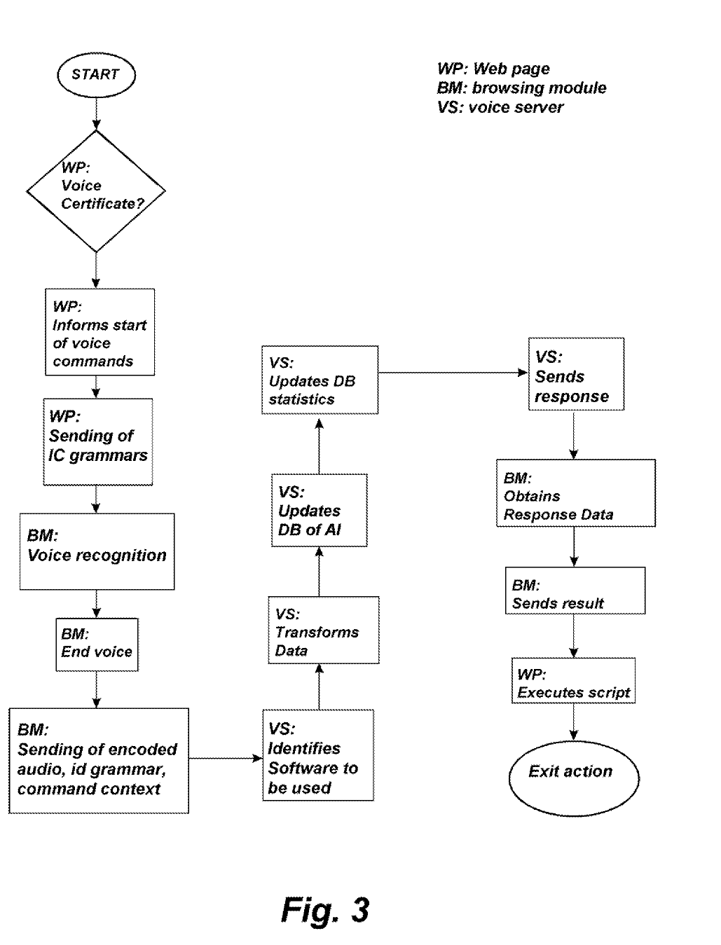

In the most general case of use of the present invention and as is illustrated in FIG. 3, it is requested from the system of the invention a generic voice-handling procedure in the voice server (5).

In accordance with the block diagram of FIG. 3, the first stage of the process consists in verifying that the Web page has a suitable certificate for recognizing and implementing the system peculiar to the present invention. The page is structured by means of DOM so that the module can (6) readily obtain said certificate.

The page forewarns the voice module (6) to prepare itself for receiving voice instructions associated with a particular voice procedure, in this general case without specifying with what grammar it is associated, and a CI (Context Identifier).

The voice module (6) recognizes the purpose of the user's speech that has been received through its own voice means, a microphone, in said Terminal (1).

Said voice module (6) encodes and compresses the voice flow and transmits it to said voice Server (5) or speech-procedure server by adding information concerning the context of the requested voice service, for instance, a browsing command, a request for a products catalogue, the storage of a voice message, etc.

The voice server (5), in accordance with the information received, firstly identifies the operating procedures required for dealing with the requested voice service. It transforms and interprets the data so that the compressed flow of the received binary data becomes transformed into any member of a set of possible sentences, commands or instructions, depending on the service that has been requested.

The server updates its own Databases (DB), both the intelligence database and the statistics database concerning the use of the service, and sends the response back to said voice module (6).

The voice module (6) interprets the response and sends it to the Web page (3), which processes said response by means of the procedures or scripts that said page incorporates for the requested service. In fact, the Web page (3) programmer can set a reliability threshold margin for the received response under which said Web page (3) does not accept said response as valid and arbitrates a further verification process or either puts an end to the process. The page response does not have to involve a modification of the visible content of the page, rather, it can merely imply a variation of the inner parameter.

In the most general case, the script, which in principle can be established by any known script language for Web pages, such as Python, Javascript, Perl, Ruby, or by calls to Server functions of the Web Site (4), causes a visible exit action on the Web page (3), whose content becomes modified as a result.

### Speaker Identification Service

In this embodiment the system of the invention is used for incorporating in a Web page (3) a user identifying means based on voice recognition.

In a similar way to the more general case described above, the Web page (3) is identified by means a suitable certificate according to which the standard of the present invention is complied with.

The page issues a procedure notification to the module (6) for speaker recognition. Identification of the requested service is vital in the system because, otherwise, the voice server (5) would not know what to do with the voice data flow and would even fail to decipher to a greater extent said voice data flow due to its lacking of a context grammar with which to interpret the voice.

It is for that reason that the Web page (3) also transfers the parameters that are suitable to the requested voice function to the voice module (6). In this case, it can be the user ID to be recognized.

The page informs that the voice-receiving procedure is about to start.

The voice module (6) recognizes through its own operating procedures whether the user has finished speaking. Then it codifies and compresses the speech received and, along with the context information and the requested service, transmits all this information to the voice Server (5).

The voice server, once it is requested to identify the user of a given ID with some specific function parameters, determines in the first place the operating procedures required for performing such function and then executes them. It obviously annotates its database statistics related to service use and feeds its AI bank with the experience gained. Hereafter, it sends the obtained result to the voice module (6), which in turn sends it on, in accordance with the DOM architecture of said Web page (3), to the suitable function for handling of the response.

In this particular voice-based user identification process, it is required the existence somewhere within the network of pre-encoded voice data or records that are associated with said received user ID and are accessible to the Server (5) for permitting such identification. The response to the identification request made with a reliability margin can be, for instance, affirmative.

The Web page (3) in accordance with such a positive identification performs the procedures that are scheduled for this case in a similar manner to the manner any other satisfactory user identification is made.

### Voice-Storing Service

Finally, another possible embodiment of the system of the invention is the request for a voice-storing service, such as a farewell/welcome message to a Web page (3), or an explanation to be reproduced in certain contexts.

Firstly, the Web page (3) is queried as to whether it is in compliance with the certification according to the present invention. The page informs the module (6) of the request for the aforesaid voice-storing service and that such service is being initiated. The module (6), through the voice-receiving means of said Terminal (1), registers the user's voice, detects the end of the speech and encodes and compresses it for subsequent transmission thereof to said Speech Services Server (5) along with the request for service and context parameters, which parameters could be in this case the format used to save the file.

The voice server transforms said data, identifies the software that is required and, in the example herein described, identifies the means necessary for storing the voice in the voice format that has been requested, such as for instance the MP3 format.

On its way back the voice Server (5) sends a result code and an identifier of the generated file to the browser. The module (6) retrieves the data and by means of the DOM informs the page that has been loaded on the browser of the result, in this case the file identifier.

The script function that receives said identifier can decide, in a possible example, to send a form to a Web page containing among other data the identifier of the generated file so that the Web receiving said form can know that said file includes a link to an external audio file having the specified ID that is stored in the speech service Server (5).

It should be understood that any details related to form that do not substantially alter the essence of the invention are herein encompassed.

1-3. (canceled)

4. System for voice-based interaction on web pages, of the type permitting the incorporation of voice-handling functions on a Web page, said functions being related to both the browsing functions of a browser and the information elements provided by said Web page and, in general, to any possible function of a Web page connected with a procedure requiring the user's voice, characterized in that said system comprises:
a Terminal (1), considered in its broadest sense, that includes PC's, hand-held computers, cellular phones, digital televisions, consoles, etc. and is provided with Web browsing means, such as a browser chosen among any of the known browsers having a multimedia platform with means, of the microphone type, for receiving and reproducing sound (2);
a Web page (3), from a Web site, that is structured under the DOM (Domain Object module) or any of its extensions that at least includes a voice certification according the system of the present invention, function calls and voice services, procedures and script-language functions for interpreting the results of the voice services, script languages among any of the existing possible ones for a Web page;
a downloadable module (6), as a network resource, for incorporation thereof in a Web browser, including a least the operating procedures for recognizing the end of the user's speech, means for encoding and compressing the voice, and the operating procedures for transmitting both to the browser and to a Voice Server (5) the instructions, parameters and data flows associated with the requested voice services;
a Voice Services Server (5), as a provider of independent resources of each Web page (3), that can be formed by a sole server, a cluster of servers or be the very same server (4) of the Web site where said Web page (3) resides, and that receives the line of voice data transmitted by said module (6) through said global network, said line of voice data being applied a set of operating procedures related to each voice service implemented by said server (5), thereby transforming said receiving data into Response Data; and
the operating procedures for the scripts of said Web page (3) permitting the interaction thereof with the voice servers that are requested from said Voice Server (5), including at least the sending of parameters, the sending of service requests, the reception of data from the interpreted results resulting from said voice interaction and the response actions as regards said response data.

5. System for voice-based interaction on web pages, according to claim 4, characterized in that said Response Data provided by said Voice Server (5) include the percentage of reliability of the result obtained.

6. System for voice-based interaction on web pages, in accordance claim 4, characterized in that said module (6) includes in said data flow that is transmitted to said Voice Server (5), among other data, the “ID” of said Terminal (1); said ID being formed by any key means capable of verifying the identity of said Terminal (1) and/or the user thereof; including a subscription means of said Web page (3) to a voice service.

7. System for voice-based interaction on web pages, in accordance with claim 5, characterized in that said module (6) includes in said data flow that is transmitted to said Voice Server (5), among other data, the “ID” of said Terminal (1); said ID being formed by any key means capable of verifying the identity of said Terminal (1) and/or the user thereof; including a subscription means of said Web page (3) to a voice service.
